(19) United States
(12) Patent Application Publication
(10) Pub. No.: US 2019/0188748 A1
(43) Pub. Date: Jun. 20, 2019

(54) PRODUCT REGISTRATION DEVICE AND PRODUCT REGISTRATION METHOD

(71) Applicant: TOSHIBA TEC KABUSHIKI KAISHA, Tokyo (JP)

(72) Inventor: Yosuke Okawa, Shizuoka (JP)

(21) Appl. No.: 16/214,410

(22) Filed: Dec. 10, 2018

(30) Foreign Application Priority Data
Dec. 15, 2017 (JP) 2017-240644

(51) Int. Cl. G06Q 30/02; G06Q 20/20

(52) U.S. Cl. CPC G06Q 30/0233; G06Q 20/209

(57) ABSTRACT

A product registration device includes display means, selection means, setting means, and output means. The display means displays a list of purchasing products registered as purchasing targets. The selection means selects a product to be exchanged with the points possessed by a purchaser from the purchasing products on the list. The setting means sets information indicating that the product is a target for exchanging with the points for the product. The output means outputs the product for which the information is set to be distinguished from other purchasing products.

### CROSS-REFERENCE TO RELATED APPLICATION

This application is based upon and claims the benefit of priority from Japanese Patent Application No. 2017-240644, filed on Dec. 15, 2017, the entire contents of which are incorporated herein by reference.

### FIELD

Embodiments described herein relate generally to a product registration device and a product registration method.

### BACKGROUND

In the related art, in the retail industry, services such as a point service and a stamp service are provided. The point service provides predetermined points to a purchaser when a preset condition such as the purchase amount of various kinds of products and the number of visits to the store and the like is satisfied. A purchaser who possesses points can use the points as a part of a price at the time of next and succeeding purchase of a product or use the points for exchanging with the product. Similarly, the stamp service provides a stamp to the purchaser when the preset condition is satisfied, and stamps can be used for exchange with a predetermined product when the number of stamps reaches a prescribed number.

In the related art, when the purchaser utilizes the point service or the stamp service, a product registration device such as the points of sales (POS) terminal treats processing of a price discount or a discount on gift certificates for a product targeted for the service.

When the points or the stamps are used for exchanging with the product, the product registration device treats product exchange as a discount for which the purchase price is 0 yen, or treats a unit price of a product targeted for exchange as 0 yen. That is, the product registration device treats the product exchanged using the point service or the stamp service in the same manner as a product sold by other ordinary sales except that only the sales amount is different.

For that reason, even if a product exchanged utilizing the point service or the stamp service is included among a plurality of products sold, it was unable to distinguish the exchanged product in screen display, receipt printing, totalization of products sold, and the like.

### DESCRIPTION OF THE DRAWINGS

FIG. 1 is a block diagram illustrating a configuration of a product registration device according to an embodiment.

FIG. 2 is a flowchart illustrating an operation of the product registration device according to an embodiment.

FIG. 3 is a diagram illustrating an example of a registration screen used in the product registration device according to an embodiment.

FIG. 4 is a diagram illustrating an example of the registration screen used in the product registration device after a specific product is set according to an embodiment.

FIG. 5 is a diagram illustrating an example of a customer screen on a display of the product registration device according to an embodiment.

FIG. 6 is a diagram illustrating an example of a receipt issued in the product registration device according to an embodiment.

FIG. 7 is a diagram illustrating an example of an inspection report of the product registration device according to an embodiment.

### DETAILED DESCRIPTION

An exemplary embodiment provides a product registration device and a product registration method capable of distinguishing a product targeted for exchange using a service.

According to an embodiment, a product registration device includes display means, selection means, setting means, and output means. The display means displays a list of purchasing products registered as purchase targets. The selection means selects a product to be exchanged with points possessed by a purchaser from the purchasing products on the list. The setting means sets information indicating that the product is a target for exchanging with the points for the product. The output means outputs the product for which the information is set to be distinguished from other purchasing products.

Hereinafter, the embodiment will be described with reference to the drawings.

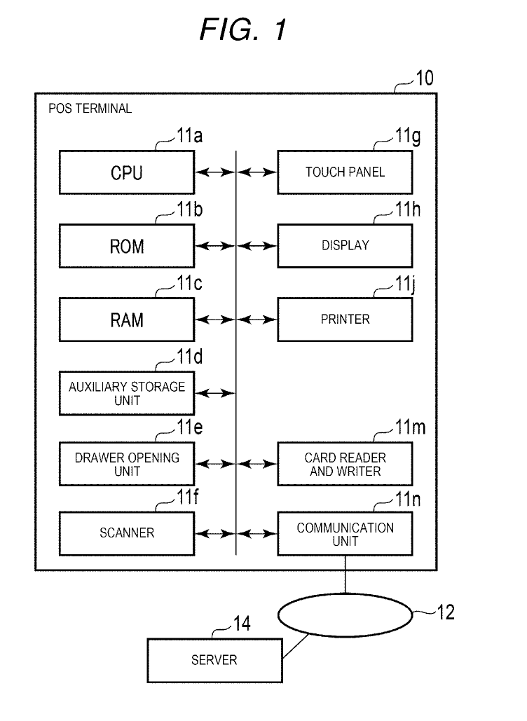

FIG. 1 is a block diagram illustrating a configuration of a product registration device 10 according to the embodiment. The product registration device 10 is connected a network 12. As the network 12, a communication network such as a local area network (LAN), the Internet, a wireless LAN, or the like can be used. The product registration device 10 can communicate with a server 13 via the network 12.

The product registration device 10 in the embodiment is provided with various functions for providing a point service and a stamp service to a purchaser. The point service provides a predetermined points to the purchaser when a preset condition such as the purchase amount of various kinds of products and the number of visits to a store and the like are satisfied. The points provided to the purchaser can be recorded in, for example, the point card or stored in a server 14 in association with identification data (membership ID and the like) unique to the purchaser who is registered as a member. A purchaser who possesses the points can use the points as a part of the price at the time of next and succeeding purchase of the product or for exchanging with the product. The stamp service provides a stamp to the purchaser when the preset condition is satisfied. The stamp provided to the purchaser can be recorded on, for example, a paper medium or stored in the server 14 as an electronic stamp in association with identification data unique to the purchaser, similarly to the point. When the number of stamps reaches a prescribed number, the purchaser can exchange the stamps with a predetermined product. As the method of managing the points and stamp, other methods than the method described above can be used.

The product registration device 10 in the embodiment registers products to be exchanged with points or stamp similarly to a purchase product that an ordinary purchaser intends to purchase, and sets information indicating that the products are targets for exchange with the points or the stamp. The product registration device 10 can display the product for which this information is selected or print the product on receipts in a format distinguishable from other purchased products.

The product registration device 10 is installed with a computer function, and includes a central processing unit (CPU) 11a, a read-only memory (ROM) 11b, a random-access memory (RAM) 11c, an auxiliary storage unit 11d, a drawer opening unit 11e, a scanner 11f, a touch panel 11g, a display 11h, a printer 11j, a card reader and writer 11m, and a communication unit 11n.

The CPU 11a is a circuit for controlling each unit to realize various operations as the product registration device 10 based on an operating system, middleware, and application programs stored in the ROM 11b and the RAM 11c.

In the ROM 11b and the RAM 11c, data to be referred to in performing various processing by the CPU 11a are recorded, in addition to various programs executed by the CPU 11a. For example, in the RAM 11c, registration product data in which information on a product targeted for purchase by a purchaser is registered is recorded when processing of registering information of a product is executed.

The program to be executed by the CPU 11a includes a product registration program for executing processing of inputting information of a product targeted for purchase according to input of a product code attached to a product by the scanner 11f or a key operation to the touch panel 11g, processing of recording transaction information (including the product name, amount, subtotal amount, information indicating that the product is a target for exchange with points, and the like) according to information of the product in the registration product data, and settlement processing based on settlement information according to the transaction information.

The auxiliary storage unit 11d stores data used in performing various processing by the CPU 11a or data generated by processing of the CPU 11a. As the auxiliary storage unit 11d, for example, a hard disk drive (HDD) and a solid state drive (SSD) can be used.

The drawer opening unit 11e receives coins and bills to be inserted, and discharges coins and bills to be changed.

For example, the scanner 11f reads information of the product by optical scanning and inputs a product code unique to the product. The scanner 11f may be a fixed type or handy type two-dimensional code scanner, or may be a type that identifies the product by using an image recognition technique from an image obtained by capturing the product.

The touch panel 11g is a device of which an input operation is made by an employee, and includes a display device and a touch sensor. The display device displays a predetermined screen such as a graphical user interface (GUI) screen. For example, the display device displays a list of registration information (the product name, amount, information indicating that the product is a target for exchange with the points, and the like) on the product registered as a purchase target, various menus, software keys for inputting various commands, and the like. As a display device, for example, a well-known device such as a color liquid crystal display (LCD) can be used. The touch sensor is disposed to overlap a display surface of the display device. The touch sensor detects a touch position of an operator on the display surface of the display device and sends the position information to the CPU 11a. It is assumed that a keyboard is provided in addition to the touch panel 11g as a device of which the input operation is made by the employee.

The display 11h is, for example, a device used as a customer display for providing information to a purchaser, and a well-known device such as a color LCD can be used as the display 11h.

The printer 11j is, for example, a thermal printer or a dot impact printer, and issues a transaction receipt, on which transaction contents such as a product name, a unit price, or a total price are printed, by printing various character strings, images, code patterns (barcode, two-dimensional code, and the like), and the like on the receipt paper.

The card reader and writer 11m reads data recorded on the card and writes data to the card. The cards include various cards for recording information on settlement processing such as a membership card and the point card, in addition to settlement cards such as a credit card, a debit card, an electronic money card, a prepaid card. The card reader and writer 11m may be any of a magnetic type device, a contact type device, or a non-contact type device, or may include a plurality of types of devices. On the point card, the points provided by using the point service to the purchaser is recorded. The points used in the point service is recorded not only in the point card but also in the server 14 in association with identification data (membership ID and the like) unique to the membership card (purchaser).

The communication unit 11n communicates with the server 14 and the like via the network 12.

Next, the operation of the product registration device 10 in the embodiment will be described.

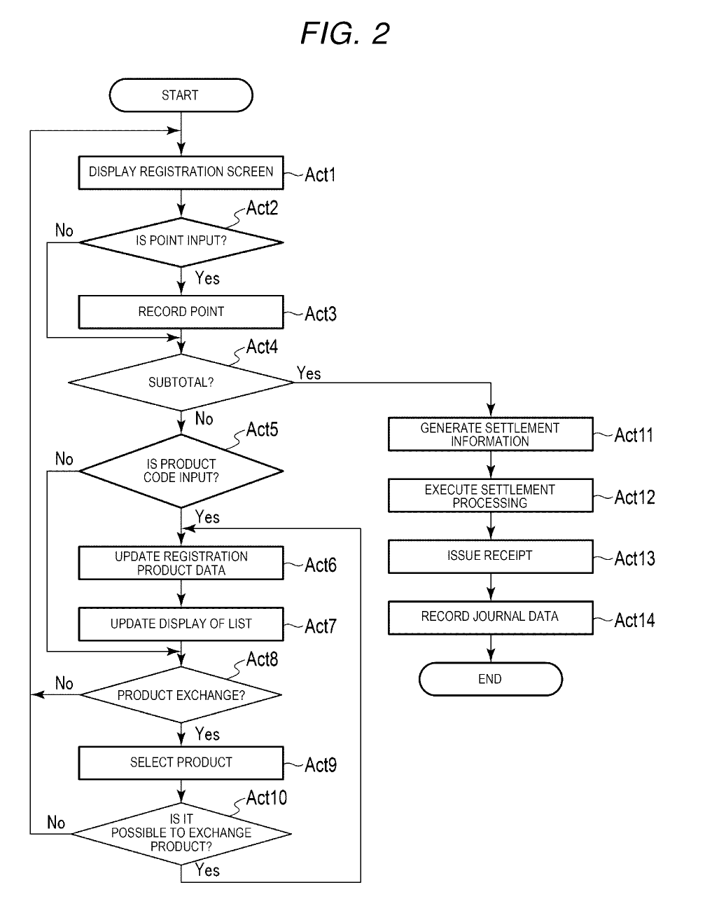

FIG. 2 is a flowchart illustrating the operation of the product registration device 10 in the embodiment. Here, a case where in which the points provided to a purchaser by a point service is used will be described by way of an example. The provision of points by the point service is realized by an existing system and detailed description thereof will be omitted. In addition, exchange with the product using the stamp provided to the purchaser by the stamp service is substantially the same as a case of exchanging the product by the point. Accordingly, in the following description, it is assumed that exchange with the product by the points can be replaced with exchange with the product by the stamp.

When product registration processing for a new purchaser is started, the CPU 11a clears an area for registration product data in the RAM 11c and displays a registration screen on the touch panel 11g for a store clerk (Act 1). The registration screen is a screen for displaying information on the product (purchased product) registered as the purchase target by the shopper, a product key for the store clerk to designate the product, various function keys, and the like.

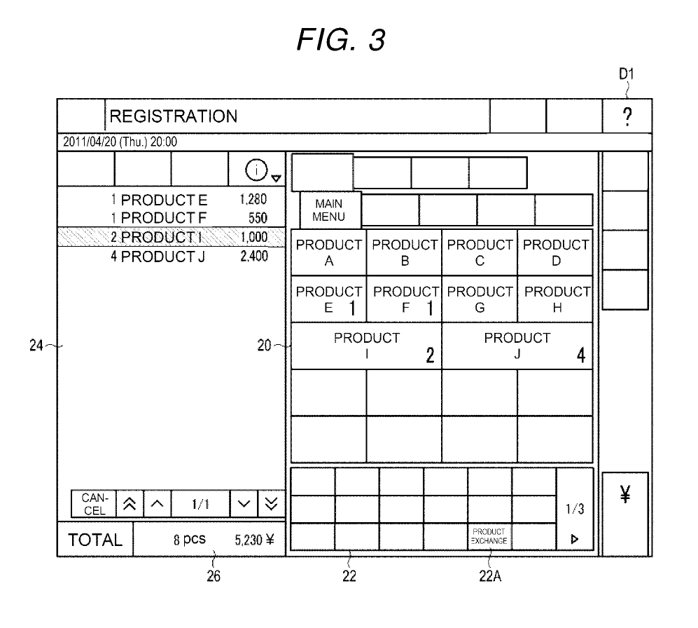

FIG. 3 is a diagram illustrating an example of a registration screen D1 used in the product registration device 10 of the embodiment.

On the registration screen D1, a plurality of product keys 20 for the store clerk to designate the product, a plurality of function keys 22 provided for each of a plurality of functions, a list 24 for displaying a list of information (transaction information) of the products registered as the purchase targets by the purchaser, a subtotal display area 26 for displaying the number of products registered in the list 24 and the subtotal amount of the products, and the like are provided.

In the product registration device 10 of the embodiment, a PRODUCT EXCHANGE key 22A is set in the function keys 22. The PRODUCT EXCHANGE key 22A is a key for instructing (declaring) selection of a product to be exchanged with the points possessed by the purchaser from the products displayed on the list 24.

In a state where the registration screen D1 is displayed, the CPU 11a waits for an event such as reading the card by the card reader and writer 11m, a touch operation to the product key 20 displayed on the screen of the touch panel 11g, a touch operation to the subtotal key for instructing settlement processing by closing accounting, input of a product code by the scanner 11f, and the like.

For example, in a case of using the points as a part of the price or intending to exchange the product using the point, the purchaser provides the point card or a membership card to the store clerk. The store clerk causes the card reader and writer 11m to read the point card or the membership card. When the points recorded on the point card is input through the card reader and writer 11m (Yes in Act 2), the CPU 11a records the points in the RAM 11c (Act 3). When the membership ID is read from the membership card through the card reader and writer 11m, the CPU 11a requests the server 14 to transmit member data recorded in association with the membership ID. When the member data is received from the server 14 (Yes in Act 2), the CPU 11a causes the RAM 11c to store data indicating the points included in the received data (Act 3).

Input of points possessed by the purchaser can be executed at any time as long as it is before the operation (accounting closure) to the subtotal key. When the points of the purchaser are input, the CPU 11a can display the number of points on the registration screen D1.

On the other hand, when it is detected that a product is designated from the product key 20 by the store clerk or the product code attached to the product is read from the scanner 11f (Yes in Act 5), the CPU 11a adds (updates) the product information (product name, unit price (amount), and the like) to the registration product data (Act 6). The CPU 11a updates display of the list 24 on the registration screen D1 according to the contents of the updated registration product data (Act 7). Thereafter, as described above, the CPU 11a sequentially adds information on the product corresponding to the acquired product code to the registration product data every time the store clerk inputs the product targeted for purchase (Acts 5 to 7).

In the list 24 of the registration screen D1 illustrated in FIG. 3, for example, a state in which one “PRODUCT E”, one “PRODUCT F”, two “PRODUCT I”, and four “PRODUCT E” are input is indicated. In the list 24, the amount is displayed for each product. In the subtotal display area 26, the score “8 PCS” of the registered purchased product displayed in the list 24 and the subtotal amount “5,230¥” are displayed.

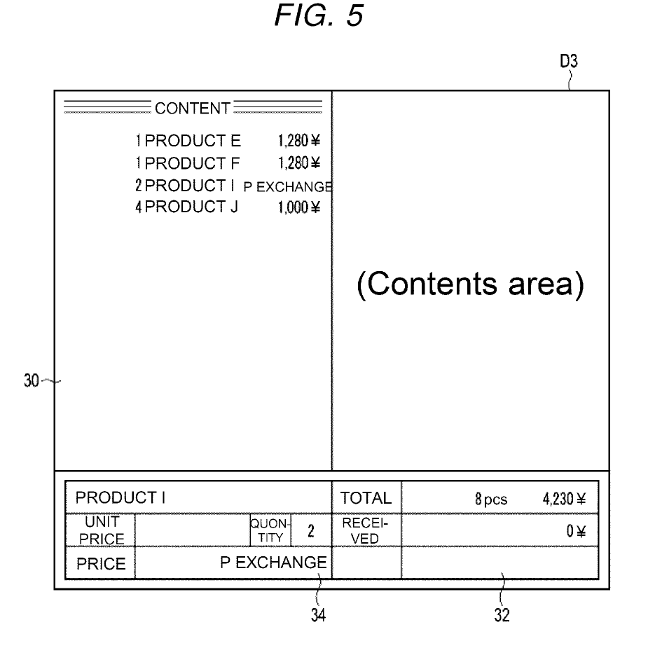

The CPU 11a causes the customer screen 11h including the same information as the list 24 and the subtotal display area 26 to be displayed on the registration screen D1 (see FIG. 5).

Thus, after at least one product is registered, it is possible to set the registered purchased product as a target for product exchange using points in response to a request from the purchaser. When a request for product exchange by the points and designation of the product targeted for exchange from the purchaser, the store clerk can set the product to be exchanged with the points by operating the PRODUCT EXCHANGE key 22A.

For example, after any purchased product is designated by the touch operation to the position where the purchased product displayed in the list 24 or by the operation to the keyboard, when it is determined that the operation to the PRODUCT EXCHANGE key 22A is detected (Yes in Act 8), the CPU 11a determines that the product exchange by the points is instructed. The CPU 11a selects the purchased product selected in the list 24 (hereinafter, may be referred to as a specific product) as a target for exchange with the points (Act 9).

Here, the CPU 11a determines whether or not the specific item can be exchanged with the points based on a preset condition. As the preset condition, for example, a condition that it is not an exchangeable product such as a cash voucher sale product, for example, that it is not a product whose unit price (amount) is provided as “0 yen” for promotion such as a promotion declared product, a condition that it is the amount that can be exchanged by the points possessed by the purchaser and the like are included. Other conditions may be set.

The amount that can be exchanged by the points possessed by the purchaser is determined according to the amount for the preset points. For example, when the points product exchange rate is set to “1 yen” for 1 point, the product of which the price (amount) is equal to or less than the points possessed by the purchaser can be exchanged for the points.

When the points possessed by the purchaser are designated to use for ordinary payment (point payment) by points rather than product exchange, the CPU 11a determines whether or not point exchange including the points used for this payment is possible.

That is, when the following condition regarding the points is satisfied, it is possible to exchange the product by the points.

Amount of specific product (number×unit price)≤(number of points possessed by purchaser−number of points for point payment)×(point product exchange rate)

In the embodiment, the product targeted for exchange is selected from the list 24. As illustrated in FIG. 3, in the list 24, when a plurality of identical products are registered, the plurality of identical products are displayed as one product (one row). For that reason, a plurality of identical products are collectively handled as a target to be exchanged (specific product) with points. In the list 24 of the registration screen D1 illustrated in FIG. 3, for example, a state in which two “PRODUCT I” are designated by the store clerk's operation is indicated. In this case, two “PRODUCT I” (price “1000¥”) become the target to be exchanged (specific product) with points. When a plurality of identical products are purchased, it becomes possible to designate a specific product targeted for exchange with the points from the plurality of identical products by registering the products in units of products (one or plural) targeted for exchange with the points.

When the points possessed by the purchaser is already input, the CPU 11a may display the products that can be exchanged with points among the purchased products displayed in the list 24 in a form different from that of the product that makes point exchange impossible, based on the determination result based on the conditions described above. For example, as a display form, it is possible to use a method such as changing a character color or a background color and adding a specific mark or symbol in association with the product name.

With this configuration, when a specific product targeted for product exchange is designated from the list 24, it is possible to identify in advance whether the product requested for the exchange target from the purchaser is exchangeable, and it is possible to facilitate the operation of selecting the specific product from the plurality of purchased product.

As a result of determining whether or not the specific product described above is exchangeable for points, when it is determined that it is not possible to exchange the specific product with the points (No in Act 10), the CPU 11a displays an error indication on the touch panel 11g (or outputting an error sound or the like) to notify that the product exchange setting could not be made, for example. Thereafter, the CPU 11a returns to the state of product registration.

As a result of determining whether or not the specific item described above can be exchanged for points, when it is determined that the specific product can be exchanged for points (Yes in Act 10), the CPU 11a updates data on the specific product in the registration product data (Act 6). That is, the CPU 11a sets the amount of the specific product to “0 yen” and sets information indicating that the product is a target for exchange with the points (Act 6). The CPU 11a updates display of the list 24 on the registration screen D1 according to the contents of the updated registration product data (Act 7). Here, the CPU 11a distinguishes the specific product from other purchased product so as to indicate that the specific merchandise is set as a product (point exchange product) targeted for exchange with the points and displays the specific product.

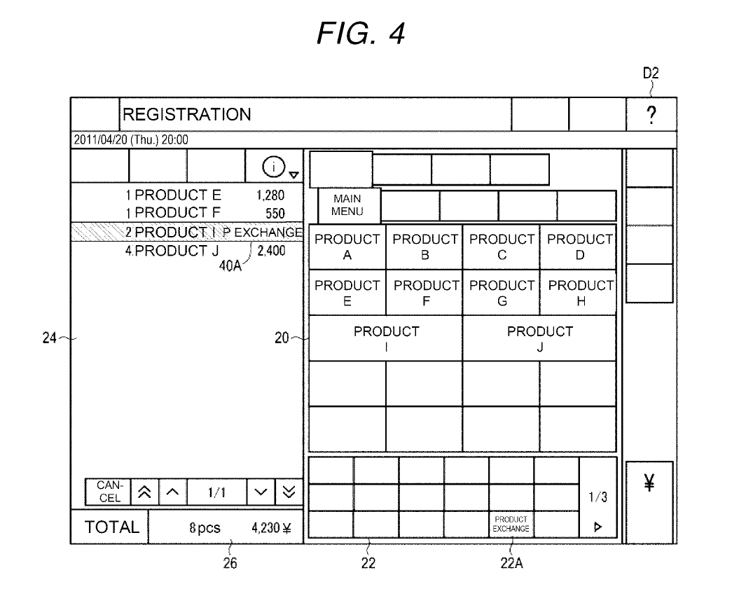

FIG. 4 is a diagram illustrating an example of a registration screen D2 after the specific product used in the product registration device 10 of the embodiment is set.

In FIG. 4, a display example in which two “PRODUCT I” are set as point exchange products is illustrated, and a specific character string “P EXCHANGE” which clearly indicates that the product is a point exchange product is added to the position indicating the amount of the product instead of displaying the amount. With this configuration, it can be easily recognized that the product is the point exchange product and is out of a calculation target of the total amount. The specific character string is not limited to “P EXCHANGE” but can be arbitrarily changed in the setting processing for the product registration device 10.

In addition to adding a specific character string, other display forms such as adding a mark, a symbol, a figure, and the like or to making the display color of the character and background different from that of other products can be used as the display form for distinguishing the product from other purchased products.

The CPU 11a does not change the purchase product score “8 pcs” in the subtotal display area 26, updates the subtotal amount to “4,230¥” obtained by subtracting the amount (“1000 yen”) of the point exchange product, and displays the subtotal amount.

The CPU 11a causes the customer screen including the same information as the list 24 and the subtotal display area 26 on the registration screen D2 illustrated in FIG. 4 to be displayed on the customer display 11h for providing information to the purchaser.

FIG. 5 is a diagram illustrating an example of a customer screen D3 on the display 11h of the product registration device 10 of the embodiment.

As illustrated in FIG. 5, on the customer screen D3, a list 30 for displaying a list of information (transaction information) of the products registered as the purchase targets, a product information display area 34 for displaying the product name, the unit price, the quantity, and the amount of the product registered in the list 30, a subtotal display area 32 for displaying the number of purchased product and the subtotal amount, and the like are provided.

As illustrated in FIG. 5, when the point exchange product is set, in the list 30, similar to the list 24, the point exchange product is distinguished from other purchased products and displayed so as to indicate that the point exchange product is set. That is, instead of displaying the amount, a specific character string “P EXCHANGE” indicating that the product is the point exchange product is added. In the product information display area 34, the product name (“PRODUCT I”) and the quantity (“2”) of the product which is set as the point exchange product are displayed and the specific character string “P EXCHANGE” is displayed in the display area of the amount. In addition, in the subtotal display area 32, the subtotal amount is updated to “4,230¥” obtained by subtracting the amount of the point exchange product (“1000 yen”) and the subtotal amount is displayed.

With this configuration, the purchaser can confirm that the exchange product with the points possessed according to the request is correctly set based on the customer screen D3 displayed on the display 11h.

Thus, after at least one product is registered, when it is determined that a touch operation to the subtotal key is detected (Yes in Act 4), the CPU 11a generates settlement information for settlement processing based on the contents registered in the registration product data (Act 11). When the operation necessary for the settlement processing is completed, the CPU 11a executes the settlement processing (Act 12). That is, the CPU 11a executes processing according to a payment method such as cash payment, credit card payment, and the like, and completes settlement. Then, the CPU 11a causes the printer 11jh to print a receipt of the result of the settlement processing and causes the receipt to be ejected (Act 13).

The CPU 11a records the contents of transaction whose settlement processing is completed as journal data (Act 14). In the journal data, setting contents of the point exchange product described above and settlement information according to setting of the point exchange product are included.

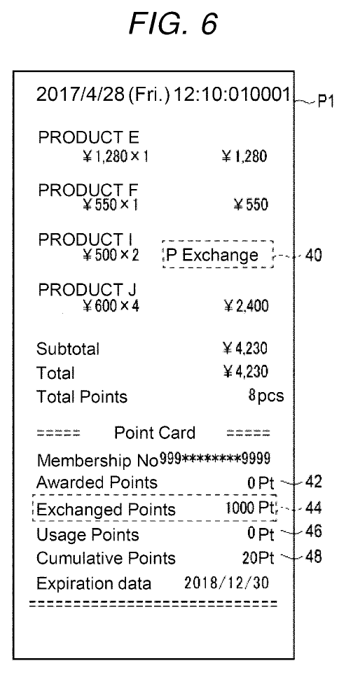

FIG. 6 is a diagram illustrating an example of a receipt P1 issued in the product registration device 10 in the embodiment.

In the receipt P1 illustrated in FIG. 6, when the purchased products include the point exchange product, in the list of the purchased products, the same specific character string “P Exchange” 40 as that of the list 24 is printed at the printing position of the amount corresponding to the point exchange product, instead of printing the amount. Thus, since the point exchange product is displayed to be distinguished from the other purchase products in the receipt P1, the purchaser can confirm the content of settlement including the point exchange product.

In the receipt P1, in addition to printing a specific character string “P Exchange” 40 as a printing form for distinguishing the point exchange product from other purchased products, it is also possible to use another printing form. It is also possible to use a form different from the list 24 on the registration screen D2. For example, displaying of the specific character string on the list 24 may be different from printing of the specific character on the receipt P1.

In the receipt P1, data on points is printed. As data relating to points, for example, the number of points 42 of this time point provided to the purchaser by this settlement (product purchase), the number of points 44 of exchange points used by product exchange, the number of points 46 of use point used as a part of price, and the number of points 48 of accumulated points possessed by the purchaser after settlement processing are included.

As illustrated in FIG. 6, since the number of points 44 of the exchange points is independently printed, it is possible to clearly ascertain the number of points used by the product exchange.

Although FIG. 6 illustrates an example of the receipt P1, the product registration device 10 can print journal data on a receipt and output the journal data. In this case, the product registration device 10 can print information relating to the point exchange product using a printing format similar to the receipt P1 illustrated in FIG. 6, for example. Output of the number of points is not limited to the receipt P1, and may be appropriately displayed on the display 11h for the customer or the display 11g for the employee, as needed.

Furthermore, in order to inspect a transaction status, the product registration apparatus 10 can execute inspection report processing of printing data obtained by summarizing the transaction status on the receipt and outputting the data. The inspection report includes, for example, a report by each transaction, a report by each product, and a report by each category. In this case, it is possible to totalize data on product exchange and print data.

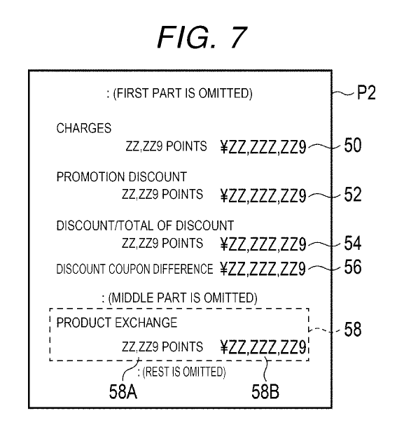

FIG. 7 is a diagram illustrating an example of an inspection report P2 of the product registration device 10 in the embodiment.

In the inspection report P2 illustrated in FIG. 7, totalization information 50 to 56 for each of the charges, the promotion discount, the discount/total of discount, and the discount coupon difference is printed, for example. In the totalization information 50 to 56, for example, the total score and the total amount of the targeted products are printed. Furthermore, totalization information 58 is also printed for product exchanges. In the totalization information 58, for example, a total score 58A of the products targeted for product exchange (point exchange product) and a total amount 58B of the products exchanged with the points (point exchange product) are printed.

Thus, in the inspection report P2, it is possible to output information on the product exchange to be distinguished from information on other transaction information in the result of totalizing a plurality of transactions. Output of the number of products exchanged with the points is not limited to the inspection report P2 and may be displayed on any one of the display 11h for the customer, the display 11g for the employee, and the receipt P1.

By doing as described above, in the product registration device 10 according to the embodiment, when the product is exchanged using the point service or the point service, in the list 24 and the list 30, it is possible to display the exchange product to be distinguished from another purchased product. After settlement processing, it is possible to print the exchange product (point exchange product) to be distinguished from other purchased products in the same manner, even in the record P1, the journal data, and the inspection report P2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Processing described in the embodiment described above can be provided to various devices by being written in various recording media such as a magnetic disk (flexible disk, hard disk, and the like), an optical disk (CD-ROM, DVD, and the like), and semiconductor memory as a program that can be executed on a computer. The program can also be provided to various devices by being transmitted through a communication medium. The computer reads a program recorded on a recording medium or receives a program via the communication medium, and the operation is controlled by the program to thereby execute the processing described above.

What is claimed is:

1. A product registration device, comprising:
a display for displaying a list of purchasing products registered as purchase targets;
a selection component for selecting a product to be exchanged with points possessed by a purchaser from the purchasing products on the list;
a setting component for setting information indicating that the product is a target for exchanging with the points; and
an output component for outputting the product for which the information is set to be distinguished from other purchasing products on the list.

2. The device according to claim 1,
wherein the output component outputs the information in association with the product.

3. The device according to claim 1,
wherein the output component outputs the number of points used for exchanging with the product.

4. The device according to claim 3,
wherein the output component outputs the number of products exchanged with the points.

5. The device according to claim 1,
wherein the setting component determines whether the product is exchangeable with the points and sets the information when it is determined that the product is exchangeable with the points.

6. The device according to claim 1,
wherein the list comprises purchasing products registered as purchase targets and the product registered as the target for exchanging with the points.

7. The device according to claim 1,
wherein the list comprises purchasing products registered as purchase targets and products registered as the targets for exchanging with the points.

8. The device according to claim 1, further comprising:
a prohibition component for setting information indicating that the product is not a target for exchanging with the points.

9. A product registration method, comprising:
displaying a list of purchasing products registered as purchase targets;
selecting a product to be exchanged with points possessed by a purchaser from the purchasing products on the list;
setting information indicating that the product is a target for exchanging with the points; and
outputting the product for which the information is set to be distinguished from other purchased products on the list.

10. The method according to claim 9, further comprising:
outputting the information in association with the product.

11. The method according to claim 9, further comprising:
outputting the number of points used for exchanging with the product.

12. The method according to claim 11, further comprising:
outputting the number of products exchanged with the points.

13. The method according to claim 9, further comprising:
determining whether the product is exchangeable with the points and sets the information when it is determined that the product is exchangeable with the points.

14. The method according to claim 9, further comprising:
setting information indicating that the product is not a target for exchanging with the points.

15. A POS terminal, comprising:
a display for displaying a list of purchasing products registered as purchase targets;
a selection component for selecting a product to be exchanged with points possessed by a purchaser from the purchasing products on the list;
a setting component for setting information indicating that the product is a target for exchanging with the points;
an output component for outputting the product for which the information is set to be distinguished from other purchasing products on the list; and
a receipt generator for providing a receipt including the list.

16. The POS terminal according to claim 15,
wherein the output component outputs the information in association with the product.

17. The POS terminal according to claim 15,
wherein the output component outputs the number of points used for exchanging with the product.

18. The POS terminal according to claim 17,
wherein the output component outputs the number of products exchanged with the points.

19. The POS terminal according to claim 15,
wherein the setting component determines whether the product is exchangeable with the points and sets the information when it is determined that the product is exchangeable with the points.

20. The POS terminal according to claim 15,
wherein the list comprises purchasing products registered as purchase targets and the product registered as the target for exchanging with the points.
